(19) United States
(12) Patent Application Publication
(10) Pub. No.: US 2019/0047138 A1
(43) Pub. Date: Feb. 14, 2019

(54) SUPPORT RAIL FOR A ROBOT PLATFORM THAT IS DISPLACEABLE IN A TRANSLATORY MANNER, AND DISPLACEMENT SYSTEM AND ROBOT SYSTEM HAVING SUCH A SUPPORT RAIL

(71) Applicants: Fredy Doll, Achern (DE); Thomas Kollmar, Flein (DE)

(72) Inventors: Fredy Doll, Achern (DE); Thomas Kollmar, Flein (DE)

(21) Appl. No.: 15/896,230

(22) Filed: Feb. 14, 2018

(30) Foreign Application Priority Data
Aug. 11, 2017 (EP) 17185995.2

(51) Int. Cl. B25J 5/04; B25J 9/02; E01B 25/10; E01B 1/00; E01B 5/08; B61B 13/04; B66C 7/08

(52) U.S. Cl. CPC B25J 5/04; B25J 9/026; E01B 25/10; B66C 7/08; E01B 5/08; B61B 13/04; E01B 1/004

(57) ABSTRACT

A support rail for a robotic platform having a support structure of concrete, a lower metallic connection flange and an upper connection flange or a guide rail disposed on an external side of the support structure. The lower connection flange, on the one hand, and the upper connection flange or the guide rail, respectively, on the other hand, are connected by a rigid metallic exoskeleton structure provided on the external side of the support structure and surrounding at least partially or completely the support structure.

### CROSS-REFERENCE TO RELATED APPLICATIONS

This claims priority from European Application No. 17185995.2, filed on Aug. 11, 2017, the disclosure of which is hereby incorporated by reference in its entirety.

### FIELD OF APPLICATION AND PRIOR ART

The invention relates to a support rail for a robot platform that is displaceable in a translatory manner, according to the preamble of claims 1 and 4. The invention furthermore relates to a displacement system having such a support rail including the robot platform, and to methods for the production of a support rail according to the invention.

Generic support rails are known in general from the prior art. These support rails which are also referred to as the seventh axis or the travel axis, serve the purpose of displacing a conventional industrial robot in a horizontal translatory manner by means of the robot platform that is attached so as to be displaceable in a translatory manner on said support rails. The demand therefor exists in many industrial fields of application, for example in manufacturing when the robot is to be employed at various locations, or in cases in which the robot according to the intended use is to be able to autonomously approach a workpiece store in order to acquire therein a workpiece to be installed. Such support rails are known in particular for the construction of passenger motor vehicles. Said support rails are here used at various processing positions in order to be able to displace a robot platform having the robot attached thereto between the rear and the front of the vehicle. Such support rails are usually several metres long, in particular approximately 6 m long.

Support rails of the generic type are usually fastened to a sub-base at a height of a few metres by means of a connection flange on the floor, in particular on a shed floor or on a gantry base. Said support rails on the upper side thereof, thus that side that does not lie opposite the necessarily horizontal sub-base, usually have a guide rail or two guide rails that run in parallel so as to be mutually spaced apart, wheels of the displaceable robot platform rolling on said guide rails.

Known support rails are configured as completely metallic support rails, in most instances from aluminium or steel. This leads to a comparatively high price of the support rails. It is moreover disadvantageous that such support rails are heavy, the transportation thereof being correspondingly complex. A production at the site of use is typically not possible.

A support rail which already has a support structure of concrete is known from the European patent application EP17162660.9 which was published after the priority date of the present application.

### OBJECT AND ACHIEVEMENT

It is an object of the invention to provide alternative construction modes for a support rail, said construction modes in relation to the conventional completely metallic support rails offering advantages in terms of costs, damping properties, and flexibility in the production.

According to a first aspect of the invention, a support rail for a robot platform that is displaceable in a translatory manner is proposed for this purpose, said support rail in a manner corresponding to that of the known support rails being configured in the manner of an elongate construction element that is aligned in a main direction of extent, having at least one metallic guide rail for guiding the robot platform, said metallic guide rail being provided on the external side and extending in the main direction of extent. The support rail in the main direction of extent preferably has a length of at least 3 m, preferably between 4 m and 8 m. Said support rail in a downward pointing part-portion has at least one lower metallic connection flange for fastening the support rail to a sub-base such as a shed floor or to a gantry base. The support rail, in an oppositely upward pointing manner, on an external side, has at least one upper metallic connection flange for attaching the metallic guide rail and/or directly the at least one metallic guide rail.

“Down” and “up” in this context relates to the coordinate system of the support rail and does not necessarily mean that the lower connection flange must be aligned towards the floor but in the direction of an attachment face which indeed in most instances can be a horizontal floor area, but also a gantry base, for example, on which the support rail can be secured by way of a lower connection flange that points to the side or even upwards.

In the case of the first variant of the invention it is provided that said support rail has a support structure of concrete which is surrounded by a metallic external structure which is formed by a metallic hollow section having a wall thickness of at maximum 8 mm. The lower metallic connection flange and the upper connection flange or the guide rail, respectively, are provided on the external side of the hollow section, or as part of the hollow section. In order for the required stability to be achieved, the support rail has a metallic internal structure which is embedded in the concrete of the support structure.

A hollow section which by way of a minor wall thickness is particularly light is used in the case of such a support rail. The preferred wall thickness of 8 mm or less, in particular of 6 mm or less, or even of 4 mm or less, alone is not capable of supporting the static and dynamic loads of a robot platform when in operation. However, it has been demonstrated that a sufficient load capacity and positive operating properties can be achieved in that the hollow section is configured by way of concrete and the metallic internal structure mentioned.

In the simplest case, the internal structure can be formed by rods that extend in the main direction of extent and are embedded completely in the support structure of concrete. A such or another internal structure preferably extends across at least 60% or even at least 80% of the overall length of the support structure. Instead of a complete embedding, it can also be provided that the internal structure at least at one end, preferably at least at both ends, is connected to the hollow section, for example by way of a screw connection or a welded connection. This facilitates the production of the support structure and permits forces to be introduced from the hollow section directly into the internal structure by way of the connections.

The internal structure preferably has a construction that is more complex than that of only rods that extend in the main direction of extent. The metallic internal structure can thus have at least one preferably rod-type longitudinal segment that is aligned in the main direction of extent, and a plurality of transverse segments which in the transverse direction rise above the longitudinal segment. A particularly solid anchoring and a reliable transmission of force from the support structure to the metallic internal structure and vice versa are achieved by way of the form-fit in relation to the main direction of extent that is established on account thereof between the support structure and the metallic internal structure. Alternatively, the metallic internal structure to this end can have a plurality of longitudinal segments that are aligned in the main direction of extent and are interconnected by way of a plurality of transverse segments. The internal structure can thus form a type of quasi metal cage, the hollow section being placed into the latter.

The support structure can be composed of simple construction concrete/cement concrete. This has the advantage of ready availability such that the production of the support structure can be performed on site at the installation site, only the hollow section and/or the internal structure and optionally further add-on parts having to be supplied. Depending on the specific field of application, it can also be expedient for higher-quality concrete in the form of polymer concrete to be used. It is also possible for the support structure to be provided with fibrous inserts, preferably with nets or mats. Such a concrete is also referred to as textile concrete.

The hollow section is preferably configured as a hollow section that is closed in an encircling manner and preferably longitudinally welded, having a uniform wall thickness. Such a hollow section represents a very simple component in particular when the former is a hollow section having a rectangular cross section. However, the cross-sectional shape of the hollow section particularly preferably deviates from the cross-sectional shape such that the latter at the side of the lower connection flange is wider than at the side of the upper connection flange.

The lower metallic connection flange and/or the upper metallic connection flange and/or the at least one metallic guide rail are preferably fastened to the external side of the hollow section by means of a welded connection. However, a design in which the flanges are a direct part of the hollow section in that said flanges are formed by localised thickenings in the section wall that have a wall thickness of more than the 8 mm mentioned, or in that the hollow section is largely formed by metal sheets which are welded in between the flanges, is also conceivable. A hollow section according to the invention does not entirely have to have a wall thickness of in particular 8 mm or less. It is sufficient for the minor wall thickness to be provided in the case of more than 50% of the wall area. However, a hollow section which entirely or almost entirely (>90%) has this minor wall thickness is preferable.

The second variant of the invention likewise proceeds from the design mentioned of a known and largely metallic support rail. Deviating therefrom, this second variant of the invention also has a support structure of concrete, the lower metallic connection flange and the upper connection flange or the guide rail, respectively, being disposed on the external side of said support structure.

It is a particular feature of this second variant that the lower connection flange, on the one hand, and the upper connection flange or the guide rail, respectively, on the other hand, are connected by a rigid metallic exoskeleton structure that is provided on the external side of the support structure and surrounds at least partially and preferably completely the support structure.

In the case of such a support rail, the external faces of the support rail accordingly are at least partially and preferably largely formed by the support structure of concrete or optionally by a non-metallic coating that is applied to said support structure. However, the exoskeleton partially forms these external faces, at least in a region between the lower connection flange, on the one hand, and the upper connection flange or the guide rail, on the other hand.

The exoskeleton structure particularly preferably has at least one encircling annular portion, and preferably a plurality of such encircling annular portions, by way of which the at least one lower connection flange, on the one hand, and the at least one upper connection flange or the at least one guide rail, respectively, on the other hand, are interconnected so as to surround the support structure in an annular manner. A high degree of stability is achieved on account thereof.

In the simplest case of a design according to this second variant, in each case only one upper connection flange and one lower connection flange which are interconnected on one side or both sides by structural elements of the exoskeleton are provided.

A design which, by virtue of the flexibility in the case of the attachment to a floor plate or to a gantry base, is particularly preferable provides that the support rail has two upper connection flanges and two lower connection flanges which are interconnected in an annular manner by way of structural elements. At least four structural elements are thus usually provided herein, said structural elements interconnecting in each case the upper and lower connection flanges, or interconnecting in pairs the upper and lower connection flanges, respectively, thus providing an annular arrangement.

When the exoskeleton structure has at least one structural element which is fastened to the at least one lower connection flange, on the one hand, and to the at least one upper connection flange or to the at least one guide rail, respectively, on the other hand, it is preferable for this to be performed by way of a welded connection.

As is the case with the first variant of the invention, this second variant can also have a metallic internal structure which is embedded in the concrete of the support structure. In terms of the design embodiment of this internal structure, the possibilities and advantages mentioned above in the context of the first variant apply.

The connection flanges mentioned or the guide rail, by way of casting the concrete to the respective component or by partially insert casting the respective component, preferably bear directly on the support structure of concrete so as to be flush with the latter, such that a particularly strong connection results here. The connection flanges and/or the guide rail are particularly preferably provided with a tie anchor which secured in a form-fitting manner reaches into the support structure of concrete.

The at least one lower metallic connection flange is preferably formed by at least one floor plate which for attaching to the sub-base has bores, wherein a plurality of mutually spaced apart floor plates are preferably provided. Alternatively, it can also be provided that the at least one lower metallic connection flange has at least one threaded bore for attaching a floor plate, wherein a plurality of threaded bores for attaching a plurality of floor plates are preferably provided.

The support rail according to the first or to the second variant of the invention described has an intended use as part of a displacement system for a robot, said displacement system apart from the at least one support rail having a robot platform on which a robot is disposed according to the intended use.

The invention furthermore relates to a method for the production of a support rail according to the first and to the second variant.

A support rail according to the second variant of the invention is preferably produced in such a manner that first a metal structure which comprises an exoskeleton and at least one lower metallic connection flange and at least one upper metallic connection flange or a guide rail, respectively, is established where said at least two parts are preferably welded to the exoskeleton, thus forming quasi part of the exoskeleton.

The metal structure thus comprises both the lower as well as the upper connection flange or optionally directly the guide rail. In particular, two upper connection flanges or guide rails, respectively, can be provided. Two separate lower connection flanges can also be provided aside the exoskeleton. The exoskeleton interconnects the upper and lower connection flanges and preferably also interconnects the plurality of connection flanges at the top and at the bottom, respectively.

The metal structure mentioned is subsequently placed into a formwork, wherein the formwork is adapted to the shape of the metal structure in such a manner that an external side of the exoskeleton at least in portions bears on the formwork in a planar manner. All structural elements of the exoskeleton which interconnect connection flanges particularly preferably bear in a planar manner on the formwork such that, conjointly with the connection flanges, an annular metallic region which forms the external side in an encircling manner results.

The formwork is subsequently cast with concrete such that the support structure is formed on account thereof, wherein the exoskeleton and the at least one connection flange or the guide rail at least in portions are disposed outside a surface of the support structure. The exoskeleton, conjointly with the connection flanges, preferably forms encircling annular external faces of metal.

A method in which first a metallic hollow section having a wall thickness of at maximum 8 mm is provided as the external delimitation of the support structure is proposed for the production of a support rail according to the first variant of the invention. Said section can have been produced, for example, as a uniform and longitudinally welded hollow section. It can however also be produced from individual metal sheets which are welded to the connection flanges and on account thereof form a hollow section.

A metallic internal structure is placed into said hollow section. Said internal structure can be positioned relative to the hollow section by way of temporary supporting means. Said internal structure can however also be fixedly connected to the hollow section.

The hollow section is subsequently cast with concrete such that the support structure is formed on account thereof, the latter being externally delimited by the walls of the hollow section and embedded in the internal structure. The support rail is finished but can be equipped with further add-on parts after the concrete has solidified.

### BRIEF DESCRIPTION OF THE DRAWINGS

Further advantages and aspects of the invention are derived from the claims and from the description hereunder of preferred exemplary embodiments of the invention which are explained hereunder by means of the figures.

FIG. 1 shows a robot system according to the invention in an overall illustration.

FIGS. 2 and 3 show a support rail according to the above-mentioned second variant of the invention.

FIG. 4 shows an alternative to the design embodiment according to FIGS. 2 and 3.

FIGS. 5A-5E highlight a method for the production of the support rail according to FIGS. 2 and 3.

FIGS. 6 and 7 show a support rail according to the above-mentioned first variant of the invention.

### DETAILED DESCRIPTION OF THE EXEMPLARY EMBODIMENTS

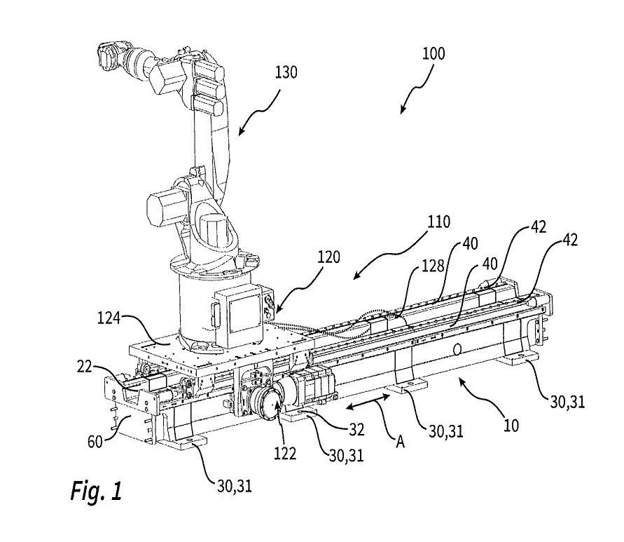

FIG. 1 shows a robot system 100 according to the invention, which can be used in particular in the course of production.

The robot system 100 has a displacement system 110 comprising a horizontally aligned support rail 10 and a platform 120 which on this support rail 10 is displaceable in the main direction of extent A of the support rail 10. The support rail 10 on the lower side thereof has connection flanges 30 in the form of floor plates 31 which are provided with bores 32 so as to be securely fastened to a sub-base, in particular to a shed floor or to a gantry base that is provided to this end. Two parallel mutually spaced apart connection flanges 40 to which in each case one guide rail 42 can be screw-fitted are provided on the upper side of the support rail 10. The platform 120 can be displaced on these guide rails, the platform 120 to this end having castors. Driving is performed by way of a motor 122 which drives a sprocket (not illustrated) which interacts with a rack of the support rail 10. Terminal detents for limiting the mobility of the platform 120 are provided in each case on the end side of the support rail 10. An industrial robot 130 having robotic arms that are pivotable in multiple axes is provided on the upper side 124 of the platform 120.

By attaching the industrial robot 130 to the platform 120 the robot gains a further degree of freedom which can be utilized, for example, to reach processing locations that are further spaced apart, or to approach a store so as to pick up components therefrom. In particular, the industrial robot 130 can thereby be moved between the rear and the front of a vehicle that is in production.

A line section 128 (illustrated with dashed lines) which is received in a trough-type channel 22 between the guide rails 42 is provided for supplying the platform 120 and the industrial robot 130.

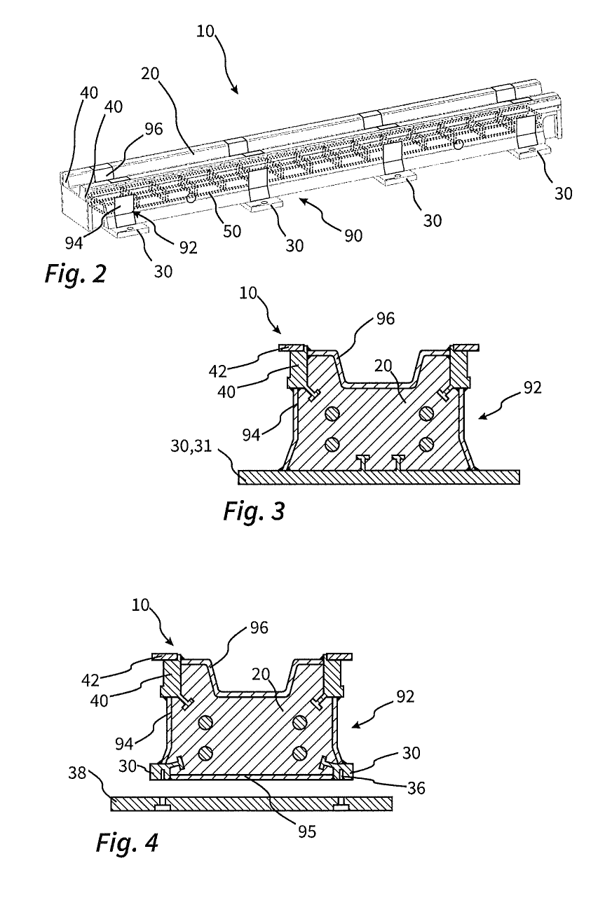

FIG. 2 shows a first variant of a support rail 10 for the robot system 100 of FIG. 1.

This support rail has the two upper connection flanges 40, already mentioned, and the floor plates 30 that form a lower connection flange. The support rail 10 is largely formed by a support structure 20 of concrete which aside the flanges and the exoskeleton structure (yet to be explained hereunder) form the external faces of the support rail 10. The upper connection flanges 40, like the lower connection flanges 30, are provided with tie anchors so as to have a secure hold in the support structure 20 of concrete. The exoskeleton structure 90, already mentioned, which is composed of metallic structural elements 94, 96 is additionally provided.

The construction is illustrated in the cross section by means of FIG. 3. It can be seen that the upper connection flanges 40 by way of lateral structural elements are connected to the lower connection flange 30. The connection between the structural elements 94 and the lower connection flange 30 and the upper connection flanges 40 here is in each case a welded connection. An upper structural element 96 which by means of welded connections is fixedly welded to both upper connection flanges 40 so as to connect the former and the latter is additionally provided, such that an overall structure that encircles the support structure 20 in an annular manner results.

As can be seen in particular by means of FIG. 2, the exoskeleton rings 92 thus formed surround the support structure 20 only partially. By contrast, the external face of the support rail 10 between the rings 92 is formed by the surface of the support structure 20 of concrete.

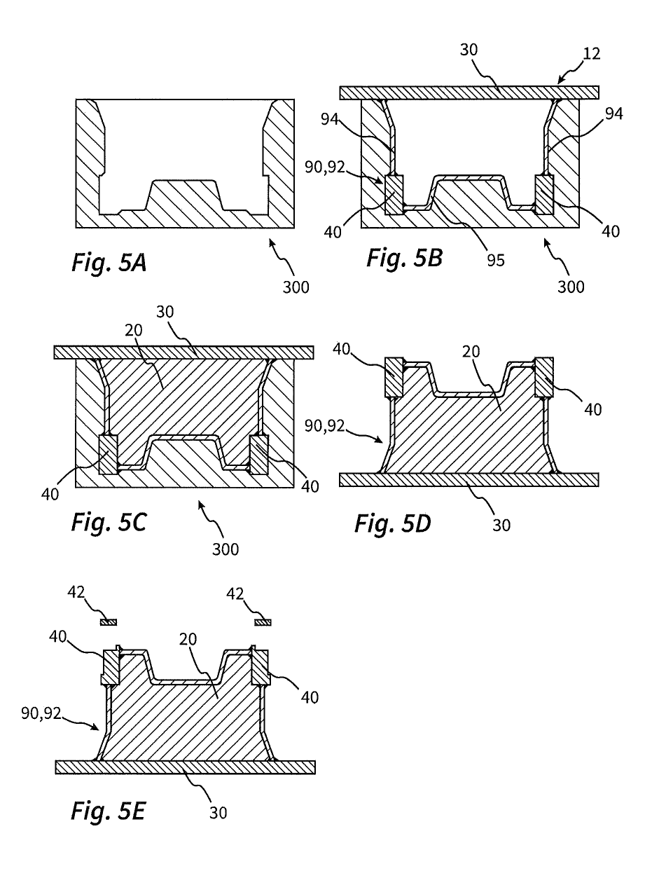

In consequence, a support rail according to FIGS. 2 and 3 is producible in a rather cost-effective manner. The weight of the metal structure having the connection flanges and the exoskeleton structure 90 is, in particular, comparatively light as compared with the overall weight of the support rail 10, this facilitating the transportation to an application site. The support structure 20 of concrete, required for the stability and in particular also for the damping of the support rail, is not particularly demanding in terms of production such that the latter can usually be performed on site. The manner of production will furthermore be explained by means of FIGS. 5A to 5E.

Before said production is discussed, reference is first made to the variant of FIG. 4. The basic concept is very similar to that of the exemplary embodiment of FIG. 3. However, two lower connection flanges 30 which are not configured in the manner of a floor plate but according to the intended use are connected to an additional floor plate by means of a screw connection are provided. For this reason, the support rail 10 of FIG. 4 has a total of four lower and upper connection flanges 30, 40. Therefore, an additional lower structural element 95 by means of which the two lower connection flanges 30 are interconnected is provided.

The production of a support rail according to FIGS. 2 and 3 will be explained by means of FIGS. 5A to 5E. FIG. 5A shows a formwork 300 which is used herein in the cross section. As is illustrated in FIG. 5B, a metal structure 12 is first placed into the formwork 300, wherein this metal structure 12 comprises both the lower connection flange 30 as well as the upper connection flanges 40, in each case in an as yet non-processed form. The metal structure 12 furthermore comprises the structural elements 94, 95, already mentioned, which by way of welded connections are connected to the flanges 30, 40, forming a type of annular structure 92.

Proceeding from this state of FIG. 5B, the incorporation of the support structure 20 of concrete is then performed. To this end, the liquid concrete is filled into the formwork such that said concrete fills the internal region which is also surrounded by the connection flanges 30, 40 and by the structural elements 94, 95. The external sides of the exoskeleton 90, in particular the external sides of the structural elements 94, 95, herein bear on the formwork 300 such that said external sides are not surrounded by concrete.

The as yet unfinished support rail 10 is removed from the formwork after the support structure 20 has cured, and in the exemplary embodiment is moved to the upright position thereof, as is shown in FIG. 5D. Subtractive machining of the connection flanges 30, 40 is finally performed. It is achieved on account thereof that any potential inaccuracies which result in the preceding manufacturing steps do not have any effect on the accuracy of the positioning of guide rails 42 which according to the intended use are attached to the upper connection flanges 40.

FIG. 5E shows the support rail 10 after subtractive machining, prior to the guide rails 42 being attached.

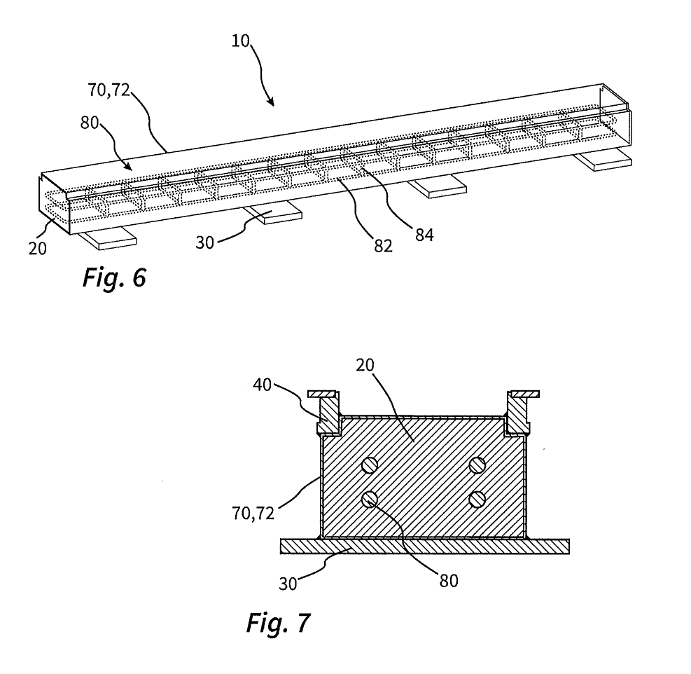

FIGS. 6 and 7 show an alternative design embodiment of a support rail 10 which however is likewise made as a composite support rail of concrete and metal.

In the case of this embodiment a metallic external structure 70 in the manner of a metallic hollow section 72 is used according to the invention, the walls of said metallic hollow section 72, having a thickness of at maximum 8 mm and preferably less than 6 mm, alone not being sufficient in order for the required loads to be supported. However, such a hollow section is comparatively cost-effective in production and above all has low material costs. In order for the required stability to be achieved the internal region of the hollow section 72 is provided with a support structure of concrete which largely fills said internal space completely. A metallic internal structure 80 which in the case of the exemplary design has a total of four longitudinal segments 82 that extend in the longitudinal direction and are interconnected by transverse segments 84 is placed into said support structure of concrete.

It has been demonstrated that such a structure, with a relevantly reduced investment of material in terms of metal, has sufficient stability for a support rail of the generic type. As is shown in FIG. 7, the support rail is additionally provided with a lower connection flange 30 on the floor side and with upper connection flanges 40 for attaching the guide rails 42, said connection flanges being welded to the external side of the hollow section 72 in this exemplary embodiment. Alternatively however, the respective connection flanges 30, 40 can also be an integral component part of the hollow section which in this instance is particularly preferably formed from metal sheets and the respective connection flanges 30, 40.

1. Support rail for a robot platform that is displaceable in a translatory manner, the support rail having the following features:
a. the support rail is configured in the manner of an elongate construction element that is aligned in a main direction of extent, having at least one metallic guide rail for guiding the robot platform, said metallic guide rail being provided on the external side and extending in the main direction of extent;
b. the support rail in a downward pointing part-portion has at least one lower metallic connection flange for fastening the support rail to a sub-base such as a shed floor or to a gantry base;
c. the support rail in an upward pointing part-portion, on an external side, has at least one upper metallic connection flange for attaching the metallic guide rail and/or directly the at least one metallic guide rail;
d. the support rail has a support structure of concrete; and
e. the support rail has a metallic external structure that surrounds the support structure and is formed by a metallic hollow section having a wall thickness of at maximum 8 mm, the lower metallic connection flange and the upper connection flange or the guide rail, respectively, being provided as part of said metallic hollow section or being provided on the external side thereof; and
f. the support rail has a metallic internal structure which is embedded in the concrete of the support structure.

2. Support rail according to claim 1, having the following additional features:
a. the metallic hollow section has a wall thickness of at maximum 6 mm, preferably of at maximum 4 mm.

3. Support rail according to claim 1, having the following additional features:
a. the lower metallic connection flange and/or the upper metallic connection flange and/or the at least one metallic guide rail is fastened to the external side of the hollow section by means of a welded connection.

4. Support rail for a robot platform that is displaceable in a translatory manner, the support rail having the following features:
a. the support rail is configured in the manner of an elongate construction element that is aligned in a main direction of extent, having at least one metallic guide rail for guiding the robot platform, said metallic guide rail being provided on the external side and extending in the main direction of extent;
b. the support rail in a downward pointing part-portion has at least one lower metallic connection flange for fastening the support rail to a sub-base such as a shed floor or to a gantry base;
c. the support rail in an upward pointing part-portion, on an external side, has at least one upper metallic connection flange for attaching the metallic guide rail and/or directly the at least one metallic guide rail;
d. the support rail has a support structure of concrete, the lower metallic connection flange and the upper connection flange or the guide rail, respectively, being disposed on the external side of said support structure; and
e. the lower connection flange, on the one hand, and the upper connection flange or the guide rail, respectively, on the other hand, are connected by a rigid metallic exoskeleton structure that is provided on the external side of the support structure and surrounds at least partially and preferably completely the support structure.

5. Support rail according to claim 4, having the following additional feature:
a. the exoskeleton structure has encircling annular portions by way of which the at least one lower connection flange, on the one hand, and the at least one upper connection flange or the at least one guide rail, respectively, on the other hand, are interconnected so as to surround the support structure in an annular manner; and
b. the support rail has two upper connection flanges and two lower connection flanges which are interconnected in an annular manner by way of structural elements.

6. Support rail according to claim 4, having the following additional features:
a. the exoskeleton structure has at least one structural element which is welded to the at least one lower connection flange, on the one hand, and to the at least one upper connection flange or to the at least one guide rail, respectively, on the other hand.

7. Support rail according to claim 4, having the following additional features:
a. the support rail has a metallic internal structure which is embedded in the concrete of the support structure.

8. Support rail according to claim 1, having the following additional features:
a. the metallic internal structure extends across at least 60% of the length, in particular across at least 80% of the length, of the support structure; and/or
b. the metallic internal structure is connected directly to the hollow section, preferably by way of a welded connection.

9. Support rail according to claim 1, having the following additional features:
a. the metallic internal structure has at least one longitudinal segment that is aligned in the main direction of extent, and a plurality of transverse segments which in the transverse direction rise above the longitudinal segment; and/or
b. the metallic internal structure has a plurality of longitudinal segments that are aligned in the main direction of extent and are interconnected by way of transverse segments.

10. Support rail according to claim 1, having the following additional feature:
a. at least one of the connection flanges or the guide rail, by way of casting the concrete to the respective component or by partially insert casting the respective component, bears directly on the support structure of concrete so as to be flush with the latter.

11. Support rail according to claim 1, having the following additional features:
a. the at least one lower metallic connection flange is formed by at least one floor plate which for attaching to the sub-base has bores, wherein preferably a plurality of mutually spaced apart floor plates are provided; or
b. the at least one lower metallic connection flange has at least one threaded bore for attaching a floor plate, wherein preferably a plurality of threaded bores for attaching a plurality of floor plates are provided.

12. Support rail according to claim 1, having at least one of the following additional features:
a. the support structure is produced from cement concrete or from polymer concrete; and/or
b. the support structure is produced from textile concrete; and/or
c. the support rail in the main direction of extent has a length of at least 3 m, preferably between 4 m and 8 m.

13. Displacement system for a robot, having the following features:
a. the displacement system has at least one support rail having at least one guide rail provided thereon;
b. the displacement system has at least one robot platform on which a robot is disposed according to the intended use; and
c. the support rail is configured according to claim 1.

14. Method for the production of a support rail for a robot platform that is displaceable in a translatory manner, according to claim 4, having the following features:
a. a metal structure which comprises an exoskeleton and at least one lower metallic connection flange and at least one upper metallic connection flange or a guide rail, respectively, is established, where said at least two parts are preferably welded to the exoskeleton; and
b. the metal structure is placed into a formwork such that an external side of the exoskeleton at least in portions bears on the framework in a planar manner; and
c. the formwork is subsequently cast with concrete such that the support structure is formed on account thereof, wherein the exoskeleton, the at least one connection flange or the guide rail at least in portions is disposed outside a surface of the support structure.

15. Method for the production of a support rail for a robot platform that is displaceable in a translatory manner, according to claim 1, having the following features:
a. a metallic hollow section having a wall thickness of at maximum 8 mm is provided as the external delimitation of the support structure; b. a metallic internal structure is placed into the hollow section; and
c. the hollow section is subsequently cast with concrete such that the support structure is formed on account thereof, the latter being externally delimited by the walls of the hollow section and embedded in the internal structure.
